(19) United States
(12) Patent Application Publication
(10) Pub. No.: US 2006/0203278 A1
(43) Pub. Date: Sep. 14, 2006

(54) Multi-function terminal device, document data management method and document data management program

(75) Inventor: Shinji Makishima, Sumida-ku (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/076,377

(22) Filed: Mar. 10, 2005

(51) Int. Cl. G06K 15/00; G06F 3/12

(52) U.S. Cl. 358/1.14; 358/1.15; 358/402

(57) ABSTRACT

There are provided a multi-function terminal device, a document data management method, and a document data management program capable of contributing to a reduction in the user's administrative workload when document data used for a conference and the like needs to be transmitted to destinations associated with the person not participated in the conference and the like.

There are provided a destination information acquisition unit 101, an image reader, and a data transmitter. The destination information acquisition unit obtains a specified destination associated with an authenticated user based on authentication information obtained by personal authentication. The image reader reads an image of a document. The data transmitter transmits image data of the document read by the image reader to the specified destination obtained by the destination information acquisition unit.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to, which is incorporated herein by reference.

### BACKGROUND OF THE INVENTION

1. Field of the Invention

The present invention relates to a multi-function terminal device, a document data management method, and a document data management program.

2. Description of the Related Art

For example, there is a need for distributing documents used for a conference to participants of the conference. In such case, there is known the conventional technique (Jpn. Pat. Appln. Laid-Open Publication No. 2000-88680). The technique uses personal authentication devices such as an IC card and a fingerprint verification device for personal authentication of each conference participant to obtain personal information such as participants' mail addresses. After the end of the conference, scanned conference minutes are e-mailed to the conference participants based on the personal information that was obtained as mentioned above.

However, in the conventional art, conference minutes are e-mailed to the conference participants. When the conference minutes need to be transferred to those who did not participate in the conference, a person responsible for the conference needs to e-mail the minutes individually by a PC and the like. This is time-consuming.

The present invention has been made in consideration of the foregoing problem. It is therefore an object of the present invention to provide a multi-function terminal device, a document data management method, and a document data management program capable of contributing to a reduction in the user's administrative workload when document data used for a conference and the like is transmitted to destinations associated with the person not participated in the conference and the like.

### DESCRIPTION OF THE DRAWINGS

FIG. 1 is a functional block diagram showing a multi-function terminal device according to a first embodiment of the present invention.

FIG. 2 is a flowchart showing an overall flow of process (document data management method) in the multi-function terminal device according to the embodiment.

FIG. 3 is a diagram showing a personal authentication process in a multi-function terminal device 1.

FIG. 4 is a diagram showing an example of personal information stored in an HDD 108.

FIG. 5 is a flowchart showing a process flow of reading a document image and transmitting data on the multi-function terminal device 1 according to the embodiment.

FIG. 6 is a diagram showing an example of displaying the UI on a display unit.

FIG. 7 is a diagram showing an example of a specified description method.

FIG. 8 is a diagram showing an example of a task management list (ToDo list).

FIG. 9 is a flowchart showing a process flow in the multi-function terminal device according to a second embodiment of the present invention.

FIG. 10 is a diagram showing another example of a specified description method.

FIG. 11 is a flowchart showing a process flow in the multi-function terminal device according to a third embodiment of the present invention.

FIG. 12 is a diagram showing another example of displaying the UI on the display unit.

### DETAILED DESCRIPTION OF THE INVENTION

Embodiments of the present invention will be described in further detail with reference to the accompanying drawings.

Throughout this description, the embodiments and examples shown should be considered as exemplars, rather than limitations on the apparatus, methods and programs of the present invention.

### First Embodiment

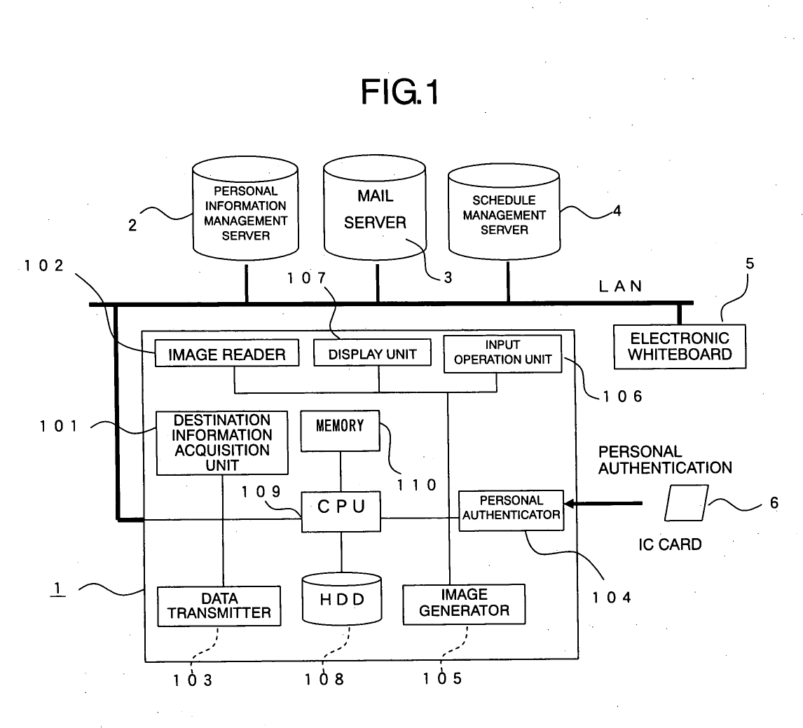

FIG. 1 is a functional block diagram showing a multi-function terminal device according to an embodiment of the present invention. The multi-function terminal device 1 according to the embodiment is composed of MFP (Multi-Function Peripherals), MMK (Multimedia Kiosk), and the like, for example.

The multi-function terminal device 1 is communicably connected with a personal information management server 2, a mail server 3, a schedule management server 4, and an electronic whiteboard 5 via an electric communication line such as LAN.

The multi-function terminal device 1 is composed of a destination information acquisition unit 101, an image reader 102, a data transmitter 103, a personal authentication unit 104, an image generator 105, an input operation unit 106, a display unit 107, an HDD 108, a CPU 109, and memory 110.

The personal authentication unit 104 performs personal authentication to obtain authentication information. Based on this authentication information, the destination information acquisition unit 101 obtains a specified destination associated with the authenticated user from the personal information management server 2.

The image reader 102 reads a document image.

After the image reader 102 reads the document's image data, the data transmitter 103 transmits this data to a specified destination obtained by the destination information acquisition unit 101.

The personal authentication unit 104 is composed of a fingerprint authentication device, an IC card reader, and the like, for example. The personal authentication unit 104 obtains authentication information used for the user's personal authentication.

The image generator 105 forms images on a sheet. The image generator 2 performs image formation processes based on data about images stored in the HDD 108.

The input operation unit 106 accepts user's input operations and is composed of a keyboard, a mouse, and the like. The display unit 107 provides screen display based on instructions from the CPU 109. For example, the display unit 107 is composed of a CRT display, a liquid crystal display, and the like. Of course, the present invention is not limited to the configuration of separately providing the display unit 107 and the input operation unit 106. The present invention may be configured to implement these functions through the use of a touch panel display, for example.

The HDD 108 is composed of a hard disk device and functions as a database and the like for storing various data used for the multi-function terminal device 1.

The CPU 109 performs various processes in the multi-function terminal device 1. In addition, the CPU 109 implements various functions by executing programs stored in the memory 110. The memory 110 is composed of ROM, RAM, and the like, for example, and stores various information and programs used for the multi-function terminal device 1.

The personal information management server 2 manages such information as personal ID information (e.g., employee number), a personal password, a personal name, a personal mail address, a personal fax number, and the like. The multi-function terminal device 1 can access the personal information management server 2 and perform personal authentication using the ID and password information or the name and password information to obtain the mail address information.

The mail server 3 manages the e-mail transmission and reception. The schedule management server 4 manages information about user scheduling (task lists, information submitted to a message board for the employee to browse, and the like).

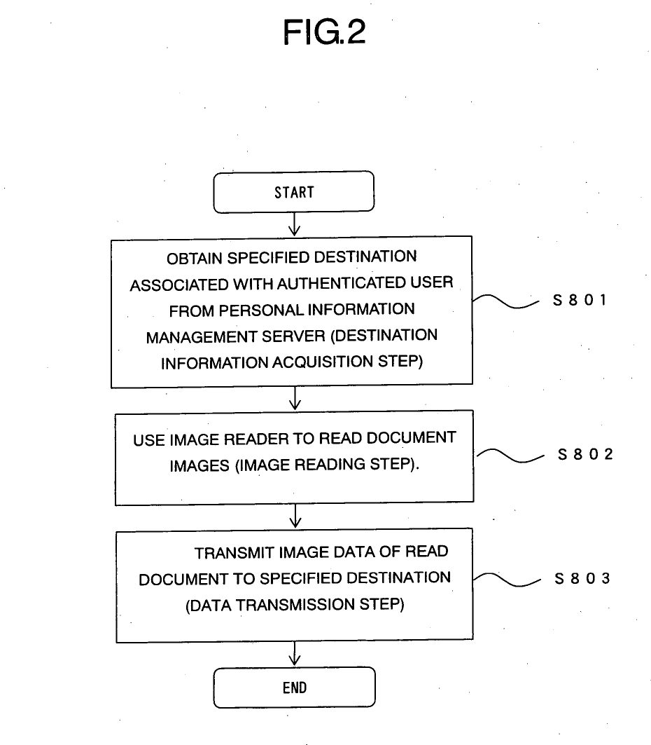

FIG. 2 is a flowchart showing an overall flow of process (document data management method) in the multi-function terminal device according to the embodiment. The embodiments of the present invention assume the following. The multi-function terminal device 1 is installed in a conference room, for example. The personal authentication unit 104 performs personal authentication for users who are participants of a conference in the conference room.

The personal authentication unit 104 obtains authentication information by means of the personal authentication using a user's (a conference participant's) IC card 6 and the like. Based on the authentication information, the destination information acquisition 102 obtains a specified destination associated with the authenticated user from the personal information management server 2 (S801) (destination information acquisition step).

The image reader 102 reads, for example, document images of papers used for the conference (S802) (image reading step).

The data transmitter 103 transmits the document image data read at the image reading step (S802) to the specified destination (S803) (data transmission step). The destination is obtained at the destination information acquisition step (S801).

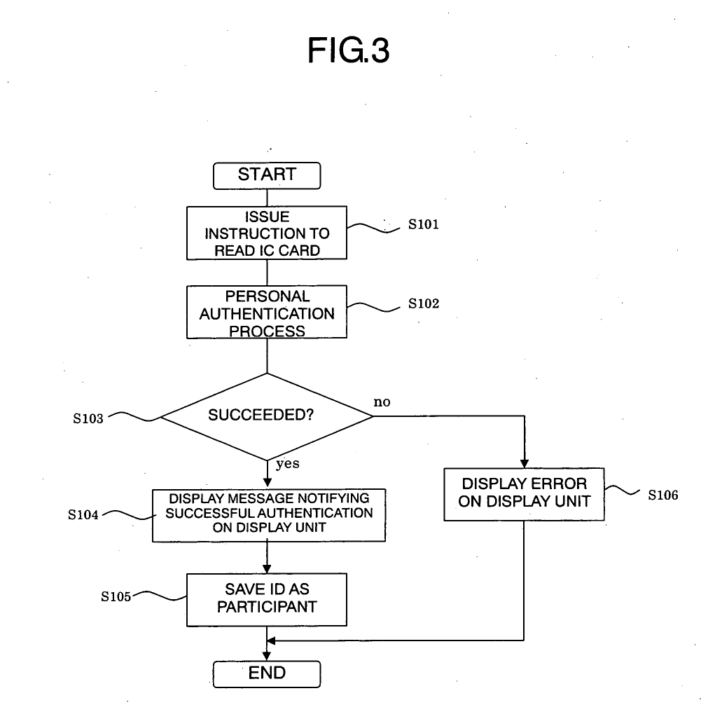

The following describes in detail the processes in the multi-function terminal device 1 according to the embodiment. FIG. 3 is a diagram showing the person authentication process in the multi-function terminal device 1.

Before the meeting such as a conference, participants of the conference notify attendance at the conference using the personal authentication unit 104 (such as an IC card reader) of the multi-function terminal device 1 to read IC cards such as employee ID cards for personal authentication (S101). The display unit 107 provides an indication prompting a user to place the IC card over the personal authentication unit 104 for the notification.

The destination information acquisition unit 101 accesses the personal information management server 2 to perform the authentication process based on personal IDs and personal names obtained from the IC cards (S102).

When the authentication process fails (No at S103), the display unit 107 displays a message notifying the unsuccessful authentication (S105). The process then terminates.

When the authentication process succeeds (Yes at S103), the display unit 107 displays a message notifying the successful authentication (S104).

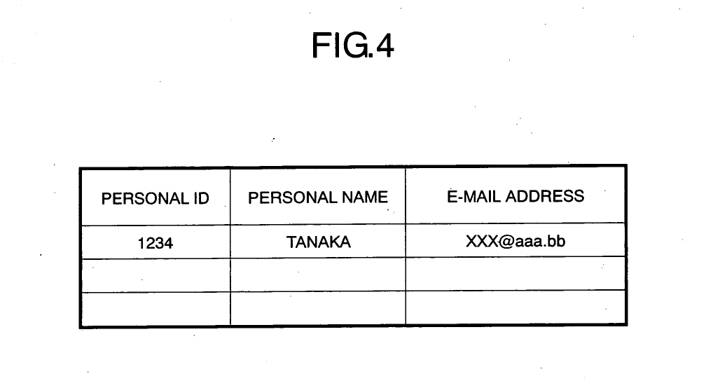

The destination information acquisition unit 101 stores information about the participants of the conference in an HDD 108 (S104). The information includes IDs or names obtained from the IC cards and users' e-mail addresses (specified destinations) and the like obtained from the personal information management server 2. The users are equivalent to the owners of the IC cards. FIG. 4 is a diagram showing an example of personal information stored in the HDD 108.

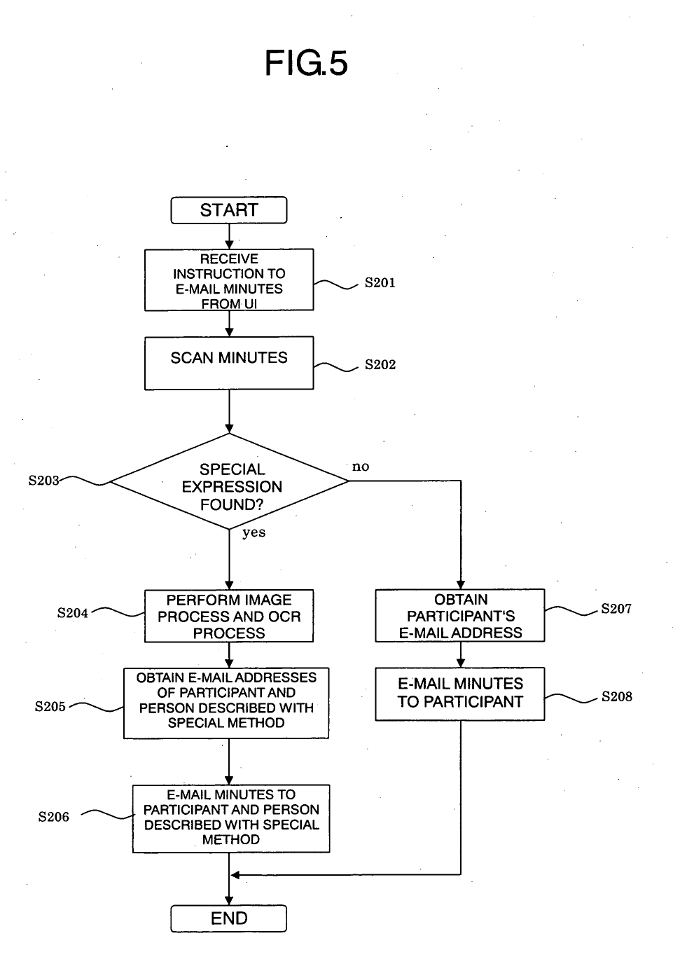

FIG. 5 is a flowchart showing a process flow of reading a document image and transmitting data on the multi-function terminal device 1 according to the embodiment.

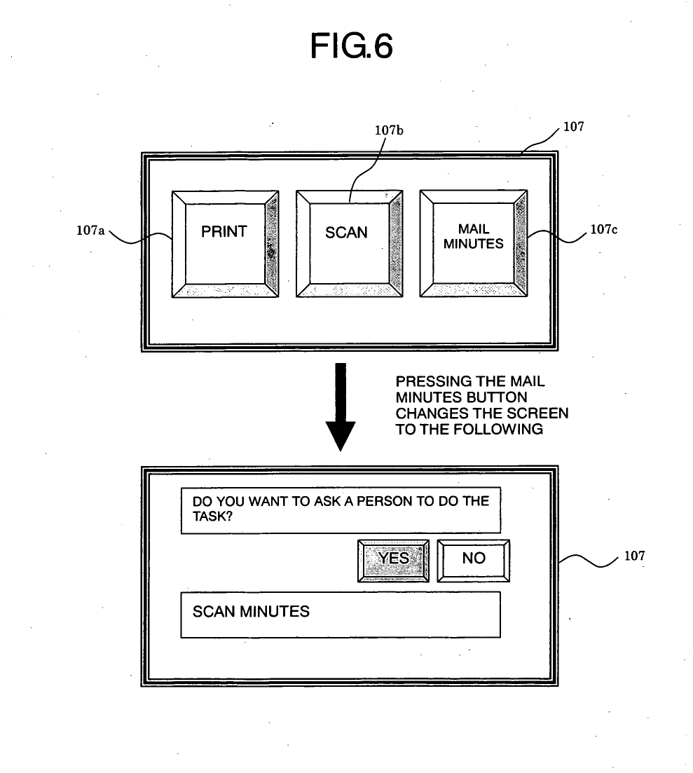

As shown in the upper part of FIG. 6, the display unit 107 can display the UI including a “Print” button 107a, a “Scan” button 107b, and a “Mail minutes” button 107c. The “Print” button 107a is used to form any image data on a sheet. The “Scan” button 107b is used to read a document image. The “Mail minutes” button 107c is used to transmit a document used for the conference. According to a user's input operation on the input operation unit 106, selecting the “Mail minutes” button 107c changes the UI display as shown in the lower part of FIG. 6 (S201).

After the UI display changes as shown in the lower part of FIG. 6, there may be a case of asking a task of a person who did not participate in the conference, i.e., transmitting the document data used for the conference to a person who did not participate in the conference. The UI of the display unit 107 displays the text “Scan minutes”. The multi-function terminal device 1 is ready for reading a document (S202).

The image reader 102 reads the document to generate image data (image reading step). The destination information acquisition unit 101 determines whether or not this image data contains description about transmission of the document data to non-participants of the conference, e.g., instructions to request a task of someone (S203).

Specifically, the destination information acquisition unit 101 determines whether or not there is found at least one of description in a specified area of the document read by the image reader 102 and description according to a specified description method in the document. When such description is available, the destination information acquisition unit 101 obtains a specified destination associated with the user corresponding to the description from the personal information management server 2 based on the description.

The specified area on the document is an area near the edge of the document such as a header, a footer, or a margin. The description in the document according to the specified description method includes at least one of the description in a color less frequently used for the general image formation or a predetermined color (specified color) and the description using a specified shape to circumscribe an intended area. Description contents according to the specified description method include, for example, the name of a recipient for transmission of the document data and ID information such as the recipient's employee number.

When it is determined that the document contains the description according to the above-mentioned specified description method (Yes at S203), the destination information acquisition unit 101 processes the image at the description part, extracts the part described with the specified method, and applies an OCR process to that part. After the OCR process, the description content (the personal name or ID) is recognized as characters and is converted into text data (S204) that is then stored in the HDD 108.

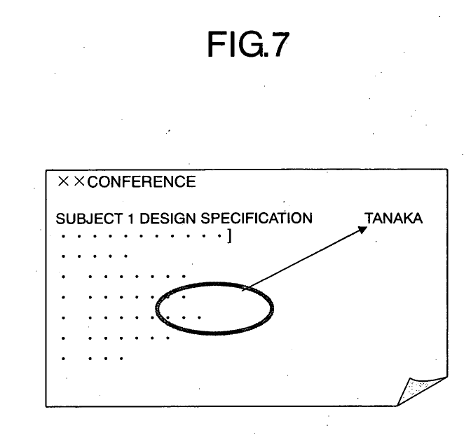

When the specified description method prescribes the description using a red marker, for example, the destination information acquisition unit 101 performs the above-mentioned image process to extract only part of the image data marked in red. The destination information acquisition unit 101 applies the OCR process to the extracted image data, converts it into text data, and obtains data of the description contents (a requester's name or ID information). As shown in FIG. 7, a given area is circumscribed with a marker in red as a specified color. In addition, a recipient's name (“Tanaka” in this example) is described. In this case, the destination information acquisition unit 101 performs the image process to extract only the circumscribed image area and recognizes the recipient's name to be “Tanaka”.

While FIG. 7 shows the example of circumscribing a given area with an oval, the present invention is not limited thereto. For example, the image area may be circumscribed with a rectangle. It is also possible to extract the circumscribed area according to the image processing technology, perform the OCR process to convert it into text data, and use the text data as the main body of e-mail. After the image process is applied to the image data as mentioned above, the processed image data is stored in the HDD 108 as needed.

After obtaining the information (name and ID information) about the recipient as mentioned above, the destination information acquisition unit 101 accesses the personal information management server 2 based on that information. The destination information acquisition unit 101 obtains an e-mail address based on the conference participant data stored in the HDD 108 according to the personal authentication process in FIG. 3 and based on the data about the recipient described on the document according to the above-mentioned specified method (destination information acquisition step) (S205).

The data transmitter 103 then e-mails the image data of the document read by the image reader 102 to the e-mail address obtained as mentioned above (S206).

When it is determined that the document does not contain the description according to the above-mentioned specified description method (No at S203), the destination information acquisition unit 101 accesses the personal information management server 2. The destination information acquisition unit 101 then obtains each participant's e-mail address based on the conference participant data stored in the HDD 108 (S207).

The data transmitter 103 e-mails the image data of the document read by the image reader 102 to the e-mail address (mail server 3) obtained as mentioned above (data transmission step) (S208). In this example, the image data is encrypted and e-mailed.

The embodiment can use the electronic whiteboard 5 during the meeting such as a conference to scan description contents on the electronic whiteboard 5. The scanned contents can be transmitted as image data to the multi-function terminal device 1. In this manner, the transmitted image data can be treated similarly to the image data of the document read by the image reader 102 of the multi-function terminal device 1.

Further, destinations of the image data transmission can use not only e-mail addresses, but also various information such as IP addresses used for the data transmission. The Bluetooth or IrDA communication can be used to transmit data to recipient's mobile devices such as a PDA and a cellular phone.

### Second Embodiment

The following describes the multi-function terminal device according to the second embodiment of the present invention.

The second embodiment is a modification of the above-mentioned first embodiment and differs from it in the process of transmitting image data. In the description below, the same parts or components described in the first embodiment are depicted by the same reference numerals and a detailed description is omitted for simplicity.

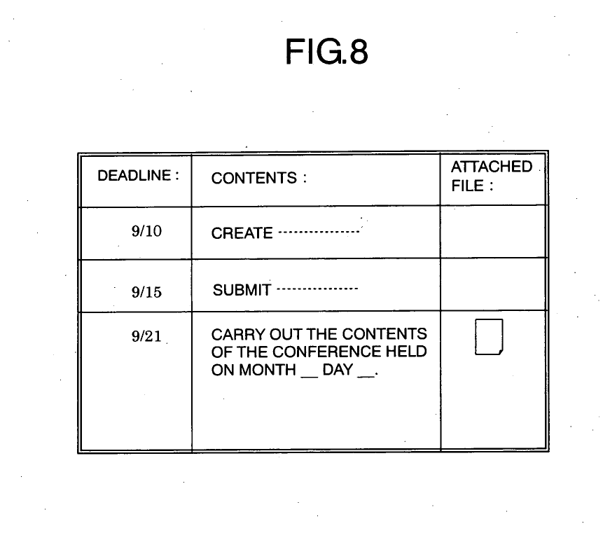

FIG. 8 is a diagram showing an example of a task management list (ToDo list) for browsing information about users' schedules managed by the schedule management server 4.

A user can use a client application running on PCs or PDAs to browse through a task management list in the message board format to post the task information about what each user must accomplish by which time limit. The task management list contains a deadline of a task to be completed, task contents, and data files associated with the task.

A task management application performs processes concerning user scheduling on the schedule management server 4. In response to an access from the outside, the schedule management server 4 may receive data about an accessing user's ID or name and content update. In this case, the task management application provides the function of updating the user's schedule record.

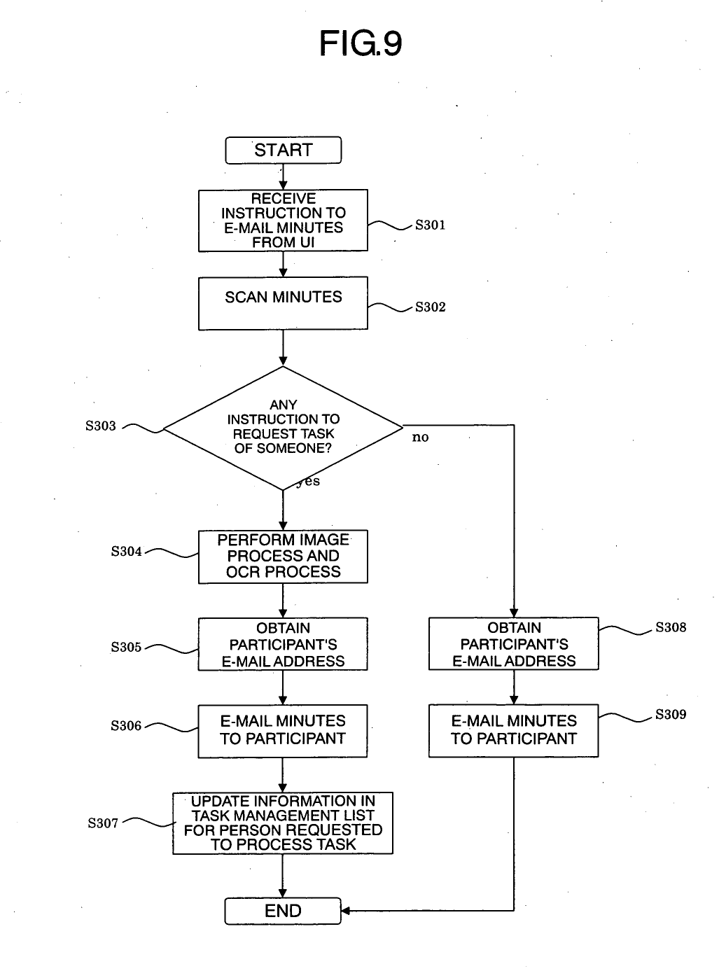

FIG. 9 is a flowchart showing a process flow (document data management method) in the multi-function terminal device according to the second embodiment.

The process at S301 and S302 in the flowchart of FIG. 9 is the same as that at S201 and S202 for the first embodiment. The following description covers the process at S303 and later.

The image reader 102 has read the image data from the document (image reading step). The destination information acquisition unit 101 determines whether or not the image data contains description about transmission of the document data to a non-participant of the conference, i.e., instructions to request a task of someone (S303).

Specifically, the destination information acquisition unit 101 determines whether or not there is at least one of the description in a specified area of the document read by the image reader 102 and the description in the document according to the specified description method. When such description is available, the destination information acquisition unit 101 obtains a specified destination associated with the user corresponding to the description from the personal information management server 2 based on the description. The specified description method is similar to that for the first embodiment.

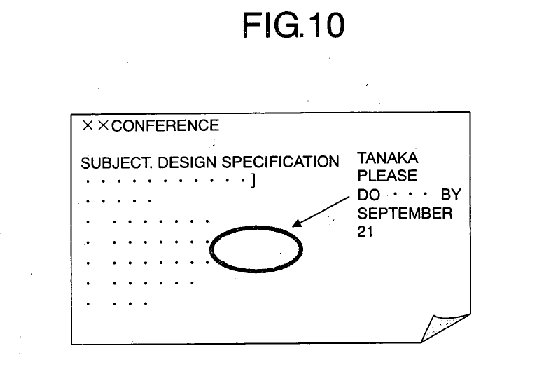

When the document contains the description according to the above-mentioned specified description method (Yes at S303), the destination information acquisition unit 101 performs the image process for that description part. The destination information acquisition unit 101 extracts the part described according to the specified description method and performs the OCR process for that part. The OCR process recognizes characters in the description (personal name, ID information, task contents, deadline, and the like). The recognized characters are converted into text data (S304) that is then stored in the HDD 108. FIG. 10 exemplifies a document that contains the description according to the above-mentioned specified description method.

The destination information acquisition unit 101 obtains respective e-mail addresses (destination information acquisition step) (S305) based on the conference participant data stored in the HDD 108 during the personal authentication process.

The data transmitter 103 then e-mails the image data of the document read by the image reader 102 to the e-mail address obtained as mentioned above (S306).

The data transmitter 103 then accesses the personal information management server 2 based on the information (name, ID information, and the like) concerning the recipient obtained from the information described on the document according to the specified description method. The data transmitter 103 transmits the document's image data to the destination, i.e., the schedule management server that manages information about the recipients' schedules (data transmission step). The data transmitter 103 transmits the image data to the schedule management server 4 to add the image data and the like to the information about the authenticated user's schedule. In this manner, the data transmitter 103 updates the information about the task content and deadline in the recipient's task list.

When it is determined that the document does not contain the description according to the above-mentioned specified description method (No at S303), the destination information acquisition unit 101 accesses the personal information management server 2. The destination information acquisition unit 101 then obtains each participant's e-mail address based on the conference participant data stored in the HDD 108 (S308).

The data transmitter 103 e-mails the image data of the document read by the image reader 102 to the e-mail address (mail server 3) obtained as mentioned above (data transmission step) (S309).

While the embodiment is configured to automatically recognize the destination described according to the specified description method to be the recipient, the present invention is not limited thereto. For example, FIG. 10 shows a case of using the specified description method to describe a requesting expression such as “Please . . . ” or any other expressions (specified expressions) of request (i.e., specified expressions included in the description). In this case, the embodiment may be configured to add the contents to the task management list. When the description contains a date and time according to the specified description method as mentioned above, the date and time may be assumed to be the task's deadline in the task list.

When there is an area circumscribed in a circle or a rectangle on the document according to the specified description method, image data corresponding to the circumscribed area can be added as a data file to the task list.

There may be a case of transferring the contents of the conference to a specialist or a person in charge who did not participate in the conference so as to ask the specialist to make inquiries into the contents or the person in charge to process the contents as a task. In such case, the embodiment can provide the specified description method to describe the requested person's name or ID information such as an employee number on a document and update the contents of his or her task management list. For example, the content of “carrying out the contents of the conference held on Month _ Day _” is added to the task management list. The minutes data is saved as an attached file.

A list (specified list) of authenticated users (conference participants in this example) may not include a recipient who is described according to the specified description method on a document read by the image reader. In such case, the data transmitter may transmit the document image data to the schedule management server and add it to the information about the schedule of the user corresponding to the description. This can avoid duplicate data transmission when there arises a need to ask a task of the authenticated conference participant.

### Third Embodiment

The following describes the multi-function terminal device according to the third embodiment of the present invention.

The third embodiment is a modification of the above-mentioned second embodiment and differs from it in the process of transmitting image data. In the description below, the same parts or components described in the second embodiment are depicted by the same reference numerals and a detailed description is omitted for simplicity.

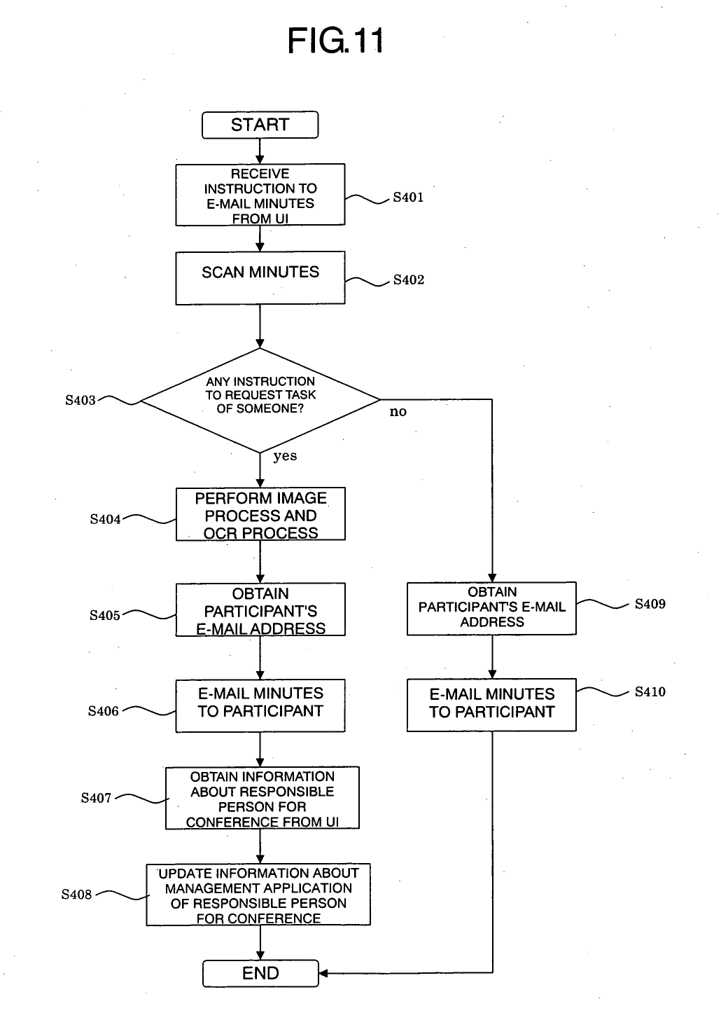

FIG. 11 is a flowchart showing a process flow (document data management method) in the multi-function terminal device according to the embodiment.

The process at S401 through S406 in the flowchart of FIG. 11 is the same as that at S301 through S306 for the second embodiment. The process at S409 and S410 in the flowchart of FIG. 11 is the same as that at S308 and S309 for the second embodiment. The following describes the process at S407 and S408.

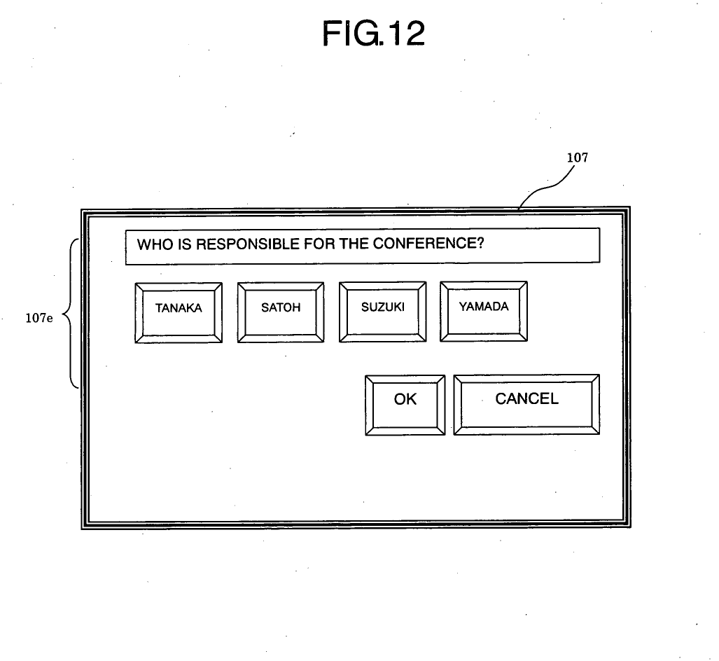

During the personal authentication (S101) in FIG. 3, the display unit 107 displays the UI as shown in FIG. 12 for users to choose a responsible person for the conference from conference participants 107e. Of course, it is possible to permit the input operation concerning the responsible person for the conference except when the personal authentication is performed. The HDD 108 stores data indicating who is the responsible person for the conference.

Based on the input operation on the input operation unit 106, the data transmitter 103 obtains information indicating who is the responsible person for the conference among the participants in the conference (S407). In addition, the data transmitter 103 can also obtain the information indicating the responsible person for the conference from the HDD 108.

The data transmitter 103 accesses the schedule management server 4. Based on the responsible person's name and ID information obtained as mentioned above, the data transmitter 103 adds the contents (e.g., “e-mailing the contents of the conference to Mr/Ms _”) of e-mailing the contents of the conference to the person requested for the task to the task list (S408). In this manner, the contents of the requested task and the information about the requested person are registered to a chairperson's task management list or ToDo list. The chairperson e-mails the registered contents of the list to the requested person.

In this manner, the embodiment can provide a solution for the case of inquiring further details about the minutes of a conference from a specialist or asking a person in charge to process the minutes as a task. When the document contains the description of a requested person's name or ID such as an employee number according to a special method, the contents of “e-mailing a person requested to process the task” can be added to the task management list of the responsible person for the conference. This provides an effect of preventing a user from forgetting the contents of a request to be submitted to someone.

According to the embodiment, scanning paper documents such as conference minutes makes it possible to easily send e-mail messages to personally authenticated participants and the other persons. It is possible to easily distribute paper documents including minutes created during a conference as digital documents.

The memory 110 stores the document data management program. The CPU 109 executes this program to implement the respective steps of the document data management method described in each of the above-mentioned embodiments.

While e-mail is used to transmit data in the above-mentioned embodiments, the present invention is not limited thereto. It is to be distinctly understood that a facsimile machine can be used as the data transmission section, for example.

Although shown implemented in a personal computer, the invention may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Although the techniques discussed herein are described with regard to a compact disk, the techniques may be implemented with any storage media in any storage device included with or otherwise coupled or attached to a computing device. These storage media include, for example, magnetic media such as hard disks, floppy disks and tape; optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include, hard disk drives, DVD drives, flash memory devices, and others.

By data unit, it is meant a frame, cell, datagram, packet or other unit of information.

While there have been described in detail specific preferred embodiments of the present invention, it is further understood by those skilled in the art that various changes and modifications may be made in the present invention without departing from the spirit and scope thereof.

As mentioned above in detail, the present invention can provide a multi-function terminal device, a document data management method, and a document data management program capable of contributing to a reduction in the user's administrative workload when document data used for a conference and the like needs to be transmitted to destinations associated with the person not participated in the conference and the like.

It is claimed:

1. A multi-function terminal device comprising:
a destination information acquisition unit that obtains a specified destination associated with an authenticated user based on authentication information obtained by person authentication;
an image reader that reads document images; and
a data transmitter to transmit image data of a document read by the image reader to a specified destination obtained by the destination information acquisition unit.

2. The multi-function terminal device according to claim 1,
wherein the specified destination is the authenticated user's e-mail address, and
the data transmitter transmits image data of the document to the e-mail address.

3. The multi-function terminal device according to claim 1,
wherein the specified destination is a schedule management server to manage information about a schedule of the authenticated user, and
the data transmitter transmits image data of the document to the schedule management server to add the image data to information about the authenticated user's schedule.

4. A multi-function terminal device comprising:
an image reader that reads document images;
a destination information acquisition unit that obtains a specified destination associated with a user corresponding to the description based on at least one of description in a specified area on a document read by the image reader and description according to a specified description method on the document; and
a data transmitter that transmits image data of a document read by the image reader to a specified destination obtained by the destination information acquisition unit.

5. The multi-function terminal device according to claim 4,
wherein the specified area on a document corresponds to the vicinity of edges on the document, and
the specified description method includes at least one of description in a specified color and description using a specified shape.

6. The multi-function terminal device according to claim 4,
wherein the specified destination is a schedule management server to manage information about a schedule of a user corresponding to the description, and
when a specified list does not contain a user corresponding to the description, the data transmitter transmits image data of the document to the schedule management server to add the image data to information about a schedule of a user corresponding to the description.

7. A document data management method comprising:
a destination information acquisition step that obtains a specified destination associated with an authenticated user based on authentication information obtained by person authentication;
an image reading step that reads an image on a document; and
a data transmission step that transmits image data of a document read by the image reading step to a specified destination obtained by the destination information acquisition step.

8. The document data management method according to claim 7,
wherein the specified destination is the authenticated user's e-mail address, and
the data transmission step transmits image data of the document to the e-mail address.

9. The document data management method according to claim 7,
wherein the specified destination is a schedule management server to manage information about a schedule of the authenticated user, and
the data transmission step transmits image data of the document to the schedule management server to add the image data to information about the authenticated user's schedule.

10. A document data management method comprising:
an image reading step that reads document images;
a destination information acquisition step that obtains a specified destination associated with a user corresponding to the description based on at least one of description in a specified area on a document read by the image reading step and description according to a specified description method on the document; and
a data transmission step that transmits image data of a document read by the image reading step to a specified destination obtained by the destination information acquisition step.

11. The document data management method according to claim 10,
wherein the specified area on a document corresponds to the vicinity of edges on the document, and
the specified description method includes at least one of description in a specified color and description using a specified shape.

12. The document data management method according to claim 10,
wherein the specified destination is a schedule management server to manage information about a schedule of a user corresponding to the description, and
when a specified list does not contain a user corresponding to the description, the data transmission step transmits image data of the document to the schedule management server to add the image data to information about a schedule of a user corresponding to the description.

13. The document data management method according to claim 10,
wherein the specified destination is a schedule management server to manage information about a schedule of a user corresponding to the description, and
when the description contains specified text, the data transmission step transmits image data of the document to the schedule management server to add the image data to information about a schedule of a user corresponding to the description.

14. A document data management program comprising:
a destination information acquisition step that obtains a specified destination associated with an authenticated user based on authentication information obtained by personal authentication;
an image reading step that reads an image on a document; and
a data transmission step that transmits image data of a document read by the image read step to a specified destination obtained by the destination information acquisition step.

15. The document data management program according to claim 14,
wherein the specified destination is the authenticated user's e-mail address, and
the data transmission step transmits image data of the document to the e-mail address.

16. The document data management program according to claim 14,
wherein the specified destination is a schedule management server to manage information about a schedule of the authenticated user, and
the data transmission step transmits image data of the document to the schedule management server to add the image data to information about the authenticated user's schedule.

17. A document data management program comprising:
an image reading step that reads document images;
a destination information acquisition step that obtains a specified destination associated with a user corresponding to the description based on at least one of description in a specified area on a document read by the image reading step and description according to a specified description method on the document; and
a data transmission step that transmits image data of a document read by the image reading step to a specified destination obtained by the destination information acquisition step.

18. The document data management program according to claim 17,
wherein the specified area on a document corresponds to the vicinity of edges on the document, and
the specified description method includes at least one of description in a specified color and description using a specified shape.

19. The document data management program according to claim 17,
wherein the specified destination is a schedule management server to manage information about a schedule of a user corresponding to the description, and
when a specified list does not contain a user corresponding to the description, the data transmission step transmits image data of the document to the schedule management server to add the image data to information about a schedule of a user corresponding to the description.

20. The document data management program according to claim 17,
wherein the specified destination is a schedule management server to manage information about a schedule of a user corresponding to the description, and
when the description contains specified text, the data transmission step transmits image data of the document to the schedule management server to add the image data to information about a schedule of a user corresponding to the description.
